(19) United States
(12) Patent Application Publication
(10) Pub. No.: US 2010/0056052 A1
(43) Pub. Date: Mar. 4, 2010

(54) ELECTRONIC DEVICE AND SEARCHING METHOD THEREOF

(75) Inventor: MING-TSANG TSAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/489,367

(22) Filed: Jun. 22, 2009

(30) Foreign Application Priority Data
Aug. 28, 2008 (CN) 200810304272.5

(51) Int. Cl. H04B 7/00

(52) U.S. Cl. 455/41.2

(57) ABSTRACT

An electronic device and searching method are provided to search for an electronic device via a BLUETOOTH (BT) connection between a BT device and a BT headset of the electronic. The electronic device and searching method include setting intensity levels of BT signals of the BT connection and one or more alarm means. The electronic device and searching method further include detecting a signal intensity of the BT signals of the BT connection, and activating one or more of the alarm means to alarm a location of the electronic device, if the signal intensity is in a low intensity level.

### BACKGROUND

1. Technical Field

Embodiments of the present disclosure relate to systems and methods for searching for an electronic device, and more particularly to a system and method for searching for the electronic device via a BLUETOOTH connection.

2. Description of Related Art

Electronic devices are getting smaller, and more easily lost or hidden from view by other objects. For example, such electronic devices may be covered by books or pillows, under a table, or somewhere else that cannot be seen by people. It is difficult to find out locations of the electronic devices.

What is needed, therefore, is an improved system and method for searching for the electronic device.

### BRIEF DESCRIPTION OF THE DRAWINGS

FIG. 1 is a block diagram of one embodiment of an electronic device.

FIG. 2 is a block diagram of one embodiment of a system for searching for the electronic device of FIG. 1.

FIG. 3 is a flowchart of one embodiment of a method for searching for the electronic device of FIG. 1

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

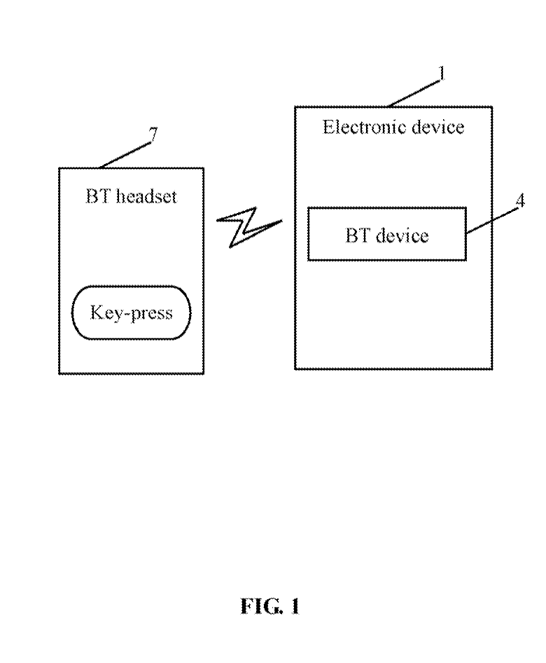

FIG. 1 is a block diagram of one embodiment of an electronic device 1. The electronic device 1 may be a mobile phone, a personal digital assistant (PDA), or any other kind of computing device, for example. The electronic device 1 may include a BLUETOOTH (BT) device 4, and a BT headset 7. The BT headset 7 may communicate with the BT device 4 through a BT connection (not shown in FIG. 1). Depending on the embodiment, the BT headset 7 provides one or more key-presses (only one shown in FIG. 1). The one or more key-presses are clickable so as to send preset control signals to the BT device 4, such as control signals of picking up a phone call, control signals of changing volumes of sounds, for example.

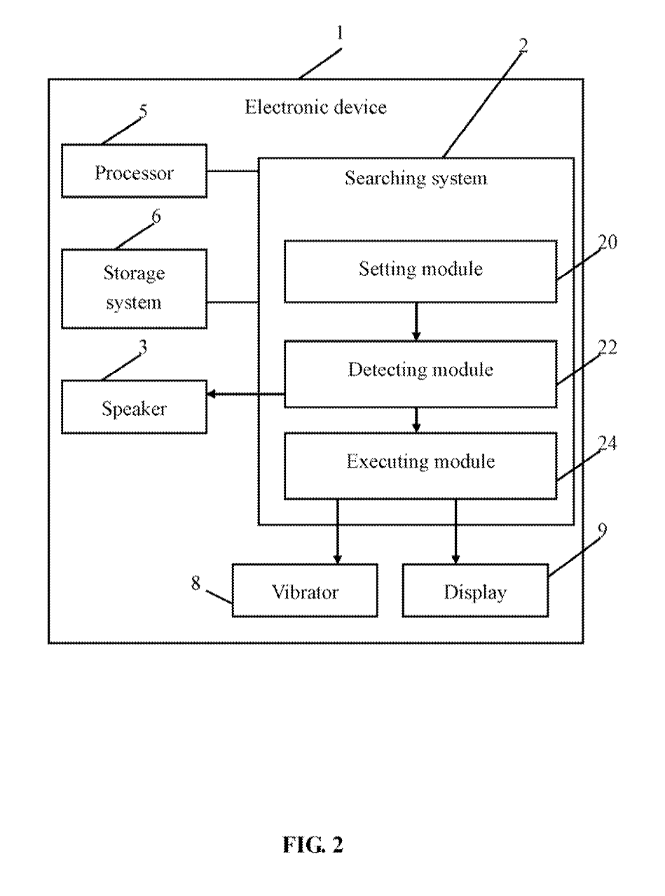

FIG. 2 is a block diagram of one embodiment of a searching system 2. The searching system 2 is operable to detect a signal intensity of BT signals from a BT connection between the BT device 4 and the BT headset 7. If the signal intensity is weak, the searching system 2 may alarm the user a location of the electronic device 1 by using preset alarm means.

The electronic device 1 includes a speaker 3, a vibrator 8, and a display 9. The speaker 3 may output audio signals, such as songs, ring tones, for example. The vibrator 8 may vibrate the electronic device 1 when a vibration mode provided by the electronic device 1 is activated. The display 9 may display various information, such as messages, images, videos, for example.

The electronic device 1 also includes a processor 5 and a storage system 6. The processor 5 executes one or more computerized operations of the electronic device 1 and other applications, to provide functions of the electronic device 1. The storage system 6 stores one or more programs, such as programs of an operating system, other applications of the electronic device 1, and various kinds of data, such as songs, images, messages, for example. In one embodiment, the electronic device 1 may be a mobile phone, and the storage system 6 may be a memory of the electronic device 1 or an external storage card, such as a memory stick, a Subscriber Identification Module (SIM) card, a smart media card, a compact flash card, or any other type of memory card.

In one embodiment, the searching system 2 includes a setting module 20, a detecting module 22, and an executing module 24. The modules 20, 22 and 24 may comprise one or more computerized codes that are stored in the storage system 6 and executed by the processor 4 to perform one or more operations of the searching system 2, such as alarm a user the location of the electronic device 1 when the electronic device 1 is out of sight.

In a first embodiment, the setting module 20 sets intensity levels of the BT signals of the BT connection between the BT device 4 and the BT headset 7. The intensity levels of the BT signals may include a high intensity level and a low intensity level, for example.

The setting module 20 also sets one or more alarm means to alarm the location of the electronic device 1. In one embodiment, the alarm means may include an audible alarm, a vibration alarm, a blinking alarm, and/or any combination of the above-mentioned alarms.

The detecting module 22 determines if the BT connection is established between the BT headset 7 and the BT device 4, and detects a signal intensity of the BT signals of the BT connection if the BT connection has been established.

The executing module 24 determines signal intensity levels between the BT device 4 and the BT headset 7. If the signal intensity is in the low intensity level, the executing module 24 may activate one or more of the alarm means to alarm the location of the electronic device 1, so as to help the user to find the electronic device 1. In one embodiment, the executing module 24 may output audio alert through the speaker 3, vibrate the electronic device 1 through the vibrator 8, and/or blink through the display 9. The audio alert may be a specified song, or specified ring tone, and may be set to output in the max volume by the speaker 4.

In a second embodiment, if the electronic device 1 is out of sight, a key-press on the BT headset 7 may be clicked/pressed/tapped to activate one ore more of the alarm means to alarm the user a location of the electronic device 1.

In the second embodiment, the setting module 20 presets a key-press on the BT headset 7 to send a search signal to the electronic device 1. In one embodiment, when the electronic device 1 is out of sight, the user of the electronic device 1 may click the preset key-press so as to send the search signal to the electronic device 1. The search signal is used to activate one or more of the alarm means preset by the setting module 20.

The executing module 24 determines if the electronic device 1 receives the search signal from the BT headset 7. If the electronic device 1 receives the search signal from the BT headset 7, the executing module 24 activates one or more of the alarm means to alarm the location of the electronic device 1, so as to help the user to find the electronic device 1.

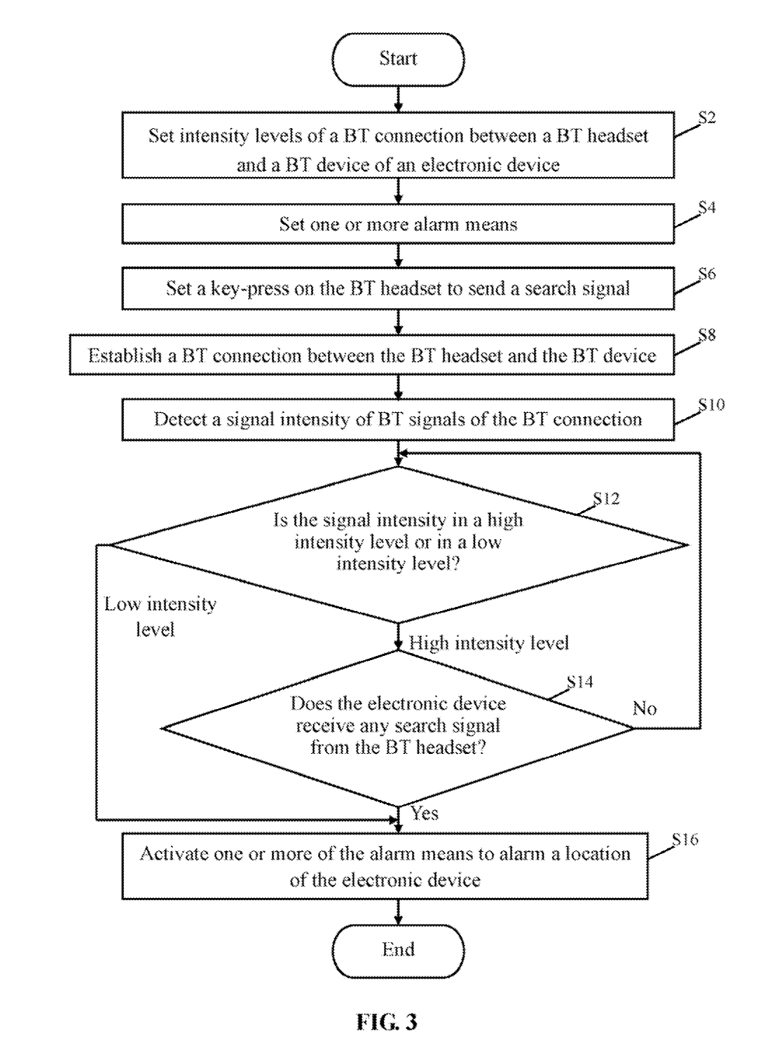

FIG. 3 is a flowchart of one embodiment of a method for searching for the electronic device 1 of FIG. 1 via a BT connection. Depending on the embodiment, additional blocks may be added, others removed, and the ordering of the blocks may be replaced.

In block S2, the setting module 20 sets intensity levels of BT signals of a BT connection between the BT device 4 and the BT headset 7. In one embodiment, the intensity levels of the BT signals may include a high intensity level and a low intensity level, for example.

In block S4, the setting module 20 sets one or more alarm means to alarm a location of the electronic device 1. In one embodiment, the alarm means may include an audible alarm, a vibration alarm, a blinking alarm, and/or any combination of the above-mentioned alarms.

In block S6, the setting module 20 presets a key-press on the BT headset 7 of the electronic device 1 to send a search signal to the electronic device 1. As mentioned above, the search signal is used to activate the alarm means to alarm the user the location of the electronic device 1.

In block S8, a BT connection is established between the BT device 4 and the BT headset 7. In block S10, the detecting module 22 detects a signal intensity of BT signals of the BT connection between the BT device 4 and the BT headset 7.

In block S12, the executing module 24 determines if the signal intensity is in the high intensity level or in the low intensity level. If the signal intensity is in the low intensity level, the procedure goes to block S16 directly. Otherwise, if the signal intensity is in the high intensity level, in block S14, the executing module 24 determines if the electronic device 1 receives any search signal from the BT headset 7. If the electronic device 1 receives the search signal from the BT headset 7, the procedure goes to block S16.

In block S16, the executing module 24 activates one or more of the alarm means to alarm the location of the electronic device 1, so as to help the user to find the electronic device 1. As mentioned above, the executing module 24 alarm the location of the electronic device 1 by outputting audio alert through the speaker 3, vibrating the electronic device 1 through the vibrator 8, and/or blinking through the display 9.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for searching for an electronic device, the electronic device comprising a BLUETOOTH (BT) device and a BT headset, the BT device being in communication with the BT headset via a BT connection, the method comprising:
setting intensity levels of BT signals of the BT connection between the BT device and the BT headset, the intensity levels comprising a high intensity level and a low intensity level;
setting one or more alarm means to alarm a location of the electronic device;
detecting a signal intensity of the BT signals of the BT connection, and determining if the signal intensity is in the high intensity level or in the low intensity level; and
activating one or more of the alarm means to alarm the location of the electronic device, if the signal intensity is in the low intensity level.

2. The method according to claim 1, further comprising:
presetting a key-press on the BT headset to send a search signal to the electronic device.

3. The method according to claim 2, further comprising:
determining if the electronic device receives the search signal from the BT headset if the signal intensity is in the high intensity level; and
activating one or more of the alarm means to alarm the location of the electronic device, if the electronic device receives the search signal from the BT headset.

4. The method according to claim 1, wherein the one or more alarm means comprise an audible alarm, a vibration alarm, a blinking alarm, and a combination of the audible alarm, the vibration alarm, and/or the blinking alarm.

5. The method according to claim 4, wherein the prompting step comprises:
outputting audio alert through a speaker of the electronic device;
vibrating the electronic device through a vibrator of the electronic device; and/or
blinking through a display of the electronic device.

6. The method according to claim 5, wherein the audio alert is output in the max volume.

7. An electronic device comprising a BLUETOOTH (BT) headset and a BT device in communication with the BT headset via a BT connection, the electronic device comprising,
a storage system;
at least one processor; and
one or more programs stored in the storage system and being executable by the at least one processor, the one or more programs comprising:
a setting module operable to set one or more alarm means to alarm a location of electronic device, and set intensity levels of BT signals of the BT connection between the BT device and the BT headset, the intensity levels comprising a high intensity level and a low intensity level;
a detecting module operable to detect a signal intensity of the BT signals of the BT connection; and
an executing module operable to determine if the signal intensity is in the high intensity level or in the low intensity level, and activate one or more of the alarm means to alarm the location of the electronic device if the signal intensity is in the low intensity level.

8. The electronic device according to claim 7, wherein the setting module is further operable to preset a key-press on the BT headset to send a search signal to the electronic device.

9. The electronic device according to claim 8, wherein the executing module is further operable to determine if the electronic device receives the search signal from the BT headset if the signal intensity is in the high intensity level, and activate one or more of the alarm means to alarm the location of the electronic device if the electronic device receives the search signal from the BT headset.

10. The electronic device according to claim 7, wherein the one or more alarm means comprise an audible alarm, a vibration alarm, a blinking alarm, and a combination of the audible alarm, the vibration alarm, and/or the blinking alarm.

11. The electronic device according to claim 10, wherein the executing module prompt the position of the electronic device by outputting audio alert through a speaker of the electronic device, vibrating the electronic device through a vibrator of the electronic device, and/or blinking through a display of the electronic device.

12. The electronic device according to claim 11, wherein the audio alert is output in the max volume.

13. A storage medium storing a set of instructions, the set of instructions capable of being executed by a processor to perform a method for searching for an electronic device, the electronic device comprising a BLUETOOTH (BT) device and a BT headset, the BT device being in communication with the BT headset via a BT connection, the method comprising:
setting intensity levels of BT signals of the BT connection between the BT device and the BT headset, the intensity levels comprising a high intensity level and a low intensity level;
setting one or more alarm means to alarm a location of the electronic device;
detecting a signal intensity of the BT signals of the BT connection, and determining if the signal intensity is in the high intensity level or in the low intensity level; and
activating one or more of the alarm means to alarm a location of the electronic device, if the signal intensity is in the low intensity level.

14. The storage medium as claimed in claim 13, wherein the method further comprises:
presetting a key-press on the BT headset to send a search signal to the electronic device.

15. The storage medium as claimed in claim 14, wherein the method further comprises:
determining if the electronic device receives the search signal from the BT headset if the signal intensity is in the high intensity level; and
activating one or more of the alarm means to alarm the location of the electronic device, if the electronic device receives the search signal from the BT headset.

16. The storage medium as claimed in claim 13, wherein the one or more alarm means comprise an audible alarm, a vibration alarm, a blinking alarm, and a combination of the audible alarm, the vibration alarm, and/or the blinking alarm.

17. The storage medium as claimed in claim 16, wherein the prompting step comprises:
outputting audio alert through a speaker of the electronic device;
vibrating the electronic device through a vibrator of the electronic device; and/or
blinking through a display of the electronic device.

18. The storage medium as claimed in claim 17, wherein the audio alert is output in the max volume.
